(19) United States
(12) Patent Application Publication
(10) Pub. No.: US 2015/0033623 A1
(43) Pub. Date: Feb. 5, 2015

(54) ADJUSTABLE PLANT SUPPORT

(71) Applicants: Ed Mauro, Palm Harbor, FL (US); John J. Kelly, Palm Harbor, FL (US)

(72) Inventors: Ed Mauro, Palm Harbor, FL (US); John J. Kelly, Palm Harbor, FL (US)

(21) Appl. No.: 13/953,824

(22) Filed: Jul. 30, 2013

(51) Int. Cl. A01G 9/12

(52) U.S. Cl. CPC A01G 9/12
USPC 47/47

(57) ABSTRACT

An adjustable plant support is disclosed. The support includes an upright support, a plurality of holes disposed along a length of the upright support, and at least one support arm configured to be removably secured to the upright support through a selected hole of the plurality of holes. The support arm also includes a hook at a distal end of the support arm and is configured to define an interior portion of the support arm and adapted to support a plant. A pin of the support arm is at a proximate end of the support arm, where a free end of the pin is configured to slidingly engage the selected hole. In addition, the pin of the support arm extends back towards the U-shape collar in a different lateral plane, where a width of the U-shaped collar is configured to slidingly engage an outer surface of the upright support.

### I. FIELD

The present disclosure is generally related to an adjustable plant support.

### II. DESCRIPTION OF RELATED ART

Staking and supporting plants is desirable to keep plants and fruit off the ground to reduce losses from rotting fruit when the fruit touches the ground. Supported plants are easier to spray and dust for insect and disease control and easier to harvest than those sprawling on the ground. Existing methods to stake a tomato plant include tying the tomato plant to a stake inserted in the ground.

Plants grown on tomato stakes must be checked daily during active growth and tied to the stake as they grow. The tomato plants must be tied securely enough so that the weight of the fruit won't pull the stake down, but not so tightly that the plant is damaged. In addition, the stake must be tall enough to accommodate the full grown size of the plant. Another type of tomato stake uses rigid hoops or rings that support the plants. A shortcoming of these types of existing plant supports is that they are not adjustable and require a large amount of effort to maintain. Accordingly, what is need in the art is an adjustable plant support system that provides the necessary support for the plants, but also does not require a large amount of time to maintain.

### III. SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In a particular embodiment, an adjustable plant support is disclosed. The support includes an upright support, a plurality of holes disposed along a length of the upright support, and at least one support arm configured to be removably secured to the upright support through a selected hole of the plurality of holes. The support arm also includes a hook at a distal end of the support arm and is configured to define an interior portion of the support arm and adapted to support a plant. A pin is at a proximate end of the support arm, where a free end of the pin is configured to slidingly engage the selected hole. In addition, the pin of the support arm extends back towards the U-shape collar in a different lateral plane, where a width of the U-shaped collar is configured to slidingly engage an outer surface of the upright support and to limit a downward rotation of the support arm to substantially perpendicular to the upright support.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### IV. BRIEF DESCRIPTION OF THE DRAWINGS

FIG. 1 is an elevational view of a particular illustrative embodiment of an adjustable plant support;

FIG. 2 is a perspective view of a removable support arm and an upright support shown in FIG. 1;

FIG. 3 is a perspective view with the support arm inserted through a hole of the upright support;

FIG. 4 is a perspective view of the support arm before being lowered down and cantilevered from the upright support; and

FIG. 5 is an elevational view of the upright support taken apart;

FIG. 6 is an elevational view of the support arm; and

FIG. 7 is a top view of the support arm taken in the direction of line 7-7.

### IV. DETAILED DESCRIPTION

The word “illustrative” is used herein to mean “serving as an example, instance, or illustration.” Any embodiment or design described herein as “illustrative” is not necessarily to be construed as preferred or advantageous over other embodiments or designs.

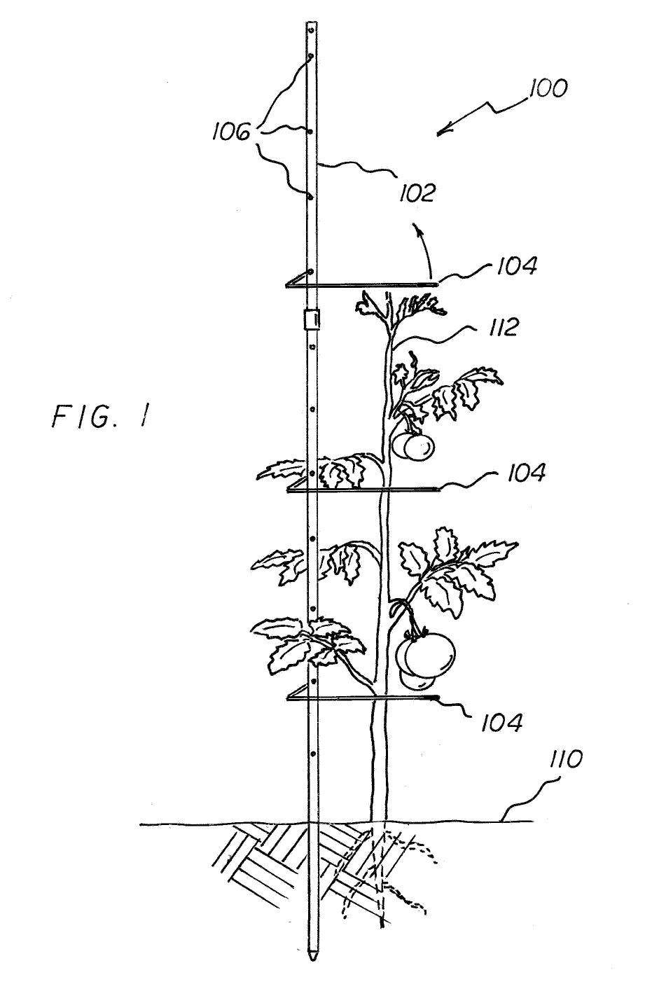

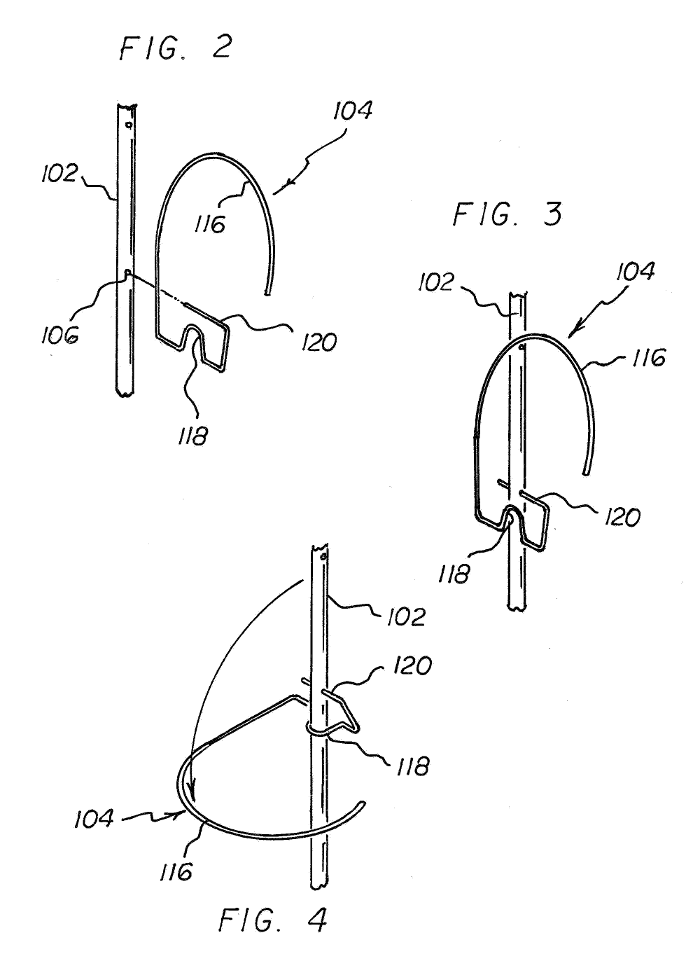

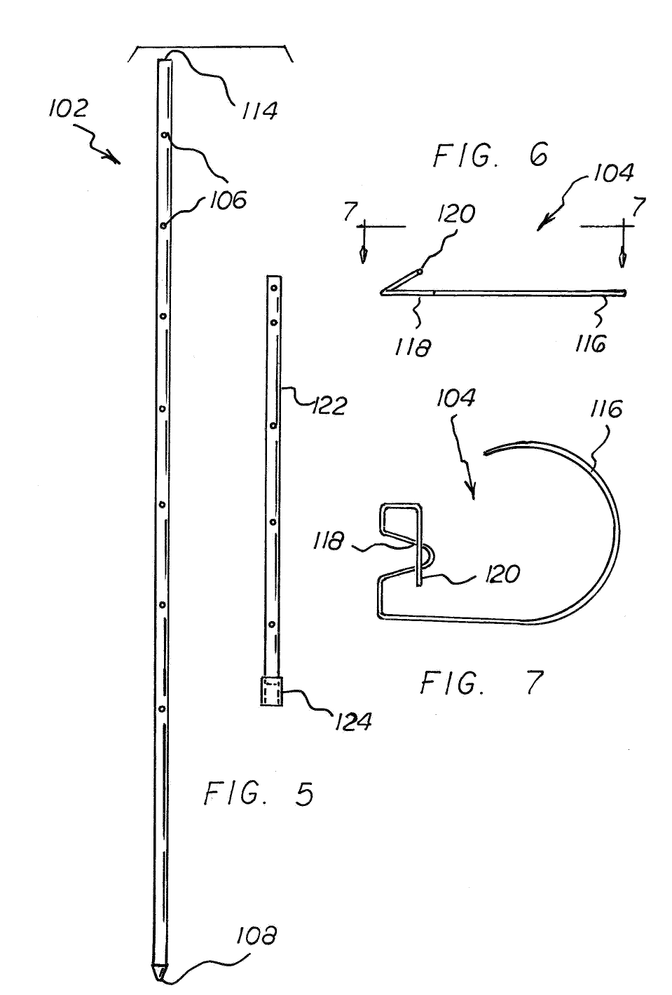

Referring now to FIGS. 1-7, an adjustable plant support is disclosed and generally designated 100. An upright support 102 (i.e., stake) is adapted to be inserted into the ground 110 using a tapered end 108 and serves as a base from which at least one support arm 104 is suspended and cantilevered outwards. The upright support 102 includes a plurality of holes 106 disposed along a length of the upright support 102 for the support arms 104. The support arms 104 are configured to be removably secured to the upright support 102 through a selected hole of the plurality of holes 106, where each support arm 104 is suspended substantially perpendicular to the upright support 102 and configured to freely pivot upwards about the selected hole. Accordingly, as a plant 112, grows upwards from the ground 110, the plant 112 is able to also pivotally move the support arm 104 upwards so that the plant 112 remains supported without having to manually adjust the support arm 104.

Initially, the support arm 104 is perpendicular to the upright support 102 so that there is no downward pressure on the plant 112 as it begins to grow. As many support arms 104 that are necessary to support the plant 112 can be added and used along the upright support 102 as the plant 112 grows. The support arms 104 can be removed and moved up the upright support 102 or addition support arms 104 can be added as the plant 112 grows.

In addition, the support arms 104 include a hook 116 at a distal end of the support arm 104, which is configured to define an interior open portion of the support arm 104 and adapted to be in contact the plant 112. As the support arm 104 includes a hook 116 rather than a fully enclosed ring or hoop, the plant 112 can be easily slid into the interior portion of the hook 112 without distressing the plant by excessive bending and movement. The support arms 104 may be a continuous member and fabricated from a metallic rod, or molded with plastic into the desired configuration and shape.

A pin 120 at a proximate end of the support arm 104 is configured to slidingly engage one of the plurality of holes 106 at a desired height along the upright support 102. A U-shaped collar 118 is interposed between the hook 116 and the pin 120, where the U-shaped collar 118 is configured to engage the upright support 102 and limit downward movement of the support arm 104. For example, the U-shaped collar 118 engages and limits a downward rotation of the support arm 104 until the support arm 104 is substantially perpendicular to the upright support 102. The pin 120 of the support arm 104 extends back towards the U-shape collar 118 in a different lateral plane. Accordingly, the pin 120 is above the U-shaped collar 118 and the hook 116 relative to the upright support 102 when the adjustable plant support 100 is assembled. The U-shaped collar 118 is configured to also prevent lateral movement of the support arm 104 and to resist wind forces, where a width of the U-shaped collar 118 is similar to a diameter of the upright support 102 and configured to slidingly engage an outer surface of the upright support 102.

A coupling 124 of a support extension 122 is configured to slidingly engage an upper end 114 of the upright support 102 to increase a height of the adjustable plant support 100. Accordingly, the adjustable plant support 100 can accommodate and adjust to a wide variety of plants that may have different height and growing characteristics.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An adjustable plant support, the support comprising:
an upright support;
a plurality of holes disposed along a length of the upright support; and
at least one support arm configured to be removably secured to the upright support through a selected hole of the plurality of holes, wherein each support arm is suspended perpendicular to the upright support and configured to freely pivot upwards about the selected hole.

2. The adjustable plant support of claim 1, the support arm further comprising:
a hook at a distal end of the support arm and configured to define an interior portion of the support arm and adapted to support a plant;
a pin at a proximate end of the support arm, wherein a free end of the pin is configured to slidingly engage the selected hole; and
a U-shaped collar interposed between the hook and the pin, wherein the U-shaped collar is configured to engage the upright support and limit downward movement of the at least one support arm.

3. The adjustable plant support of claim 2, further comprising a support extension, wherein the support extension is configured to slidingly engage an upper end of the upright support to increase a height of the adjustable plant support.

4. The adjustable plant support of claim 3, wherein the pin of the support arm extends back towards the U-shape collar in a different lateral plane.

5. The adjustable plant support of claim 4, wherein the U-shaped collar is configured to prevent lateral movement of the at least one support arm.

6. An adjustable plant support, the support comprising:
an upright support;
a plurality of holes disposed along a length of the upright support;
at least one support arm configured to be removably secured to the upright support through a selected hole of the plurality of holes, wherein the at least one support arm is a continuous member;
the at least one support arm having a U-shaped collar, wherein the U-shaped collar is configured to engage and limit a downward rotation of the at least one support arm until the support arm is substantially perpendicular to the upright support.

7. The adjustable plant support of claim 6, the support arm further comprising a hook at a distal end of the support arm and configured to define an interior portion of the support arm and adapted to support a plant.

8. The adjustable plant support of claim 7, the support arm further comprising a pin at a proximate end of the support arm, wherein a free end of the pin is configured to slidingly engage the selected hole.

9. The adjustable plant support of claim 8, wherein the pin of the support arm extends back towards the U-shape collar in a different lateral plane.

10. The adjustable plant support of claim 9, wherein a width of the U-shaped collar is configured to slidingly engage an outer surface of the upright support.

11. An adjustable plant support, the support comprising:
at least one arcuate support arm configured to be removably secured to an upright support, and the at least one arcuate support arm having a U-shaped collar, wherein the U-shaped collar is configured to engage and limit a downward rotation of the at least one arcuate support arm to substantially perpendicular to the upright support.

12. The adjustable plant support of claim 11, the at least one arcuate support arm configured to define an interior portion adapted to support a plant.

13. The adjustable plant support of claim 12, the at least one arcuate support arm further comprising a pin at a proximate end, wherein a free end of the pin is configured to slidingly engage a hole of the upright support.

14. The adjustable plant support of claim 13, wherein the pin extends back towards the U-shape collar in a different lateral plane.

15. The adjustable plant support of claim 14, wherein a width of the U-shaped collar is configured to slidingly engage an outer surface of the upright support.
